(19) United States
(12) Patent Application Publication
(10) Pub. No.: US 2010/0102046 A1
(43) Pub. Date: Apr. 29, 2010

(54) Laser Machining Medical Devices With Localized Cooling

(76) Inventors: Bin Huang, Pleasanton, CA (US); Daniel A. Castro, Mountain View, CA (US); Arzu M. Ozkan, San Jose, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 12/259,118

(22) Filed: Oct. 27, 2008

(51) Int. Cl. B23K 26/00

(52) U.S. Cl. 219/121.85

(57) ABSTRACT

Laser machining a tubular construct comprising a polymer layer to form a stent pattern in the construct with localized cooling of the machined surface to reduce or prevent heat transfer to uncut polymer of the polymer layer is disclosed.

### BACKGROUND OF THE INVENTION

1. Field of the Invention

This invention relates to laser machining techniques for fabricating medical devices.

2. Description of the State of the Art

This invention relates to laser machining of devices such as stents. Laser machining refers to removal of material accomplished through laser and target material interactions. Generally speaking, these processes include laser drilling, laser cutting, and laser grooving, marking or scribing. Laser machining processes transport photon energy into a target material in the form of thermal energy or photochemical energy. Material is removed by melting and blow away, or by direct vaporization/ablation.

The application of ultrashort-pulse lasers for high quality laser material processing is particularly useful due to the extremely high intensity (>10¹² W/cm²), ultrashort-pulse duration (<1 picosecond), and non-contact nature of the processing. Ultrashort pulse lasers allow precise and efficient processing, especially at the microscale. Compared with long-pulse lasers and other conventional manufacturing techniques, ultrashort pulse lasers provide precise control of material removal, can be used with an extremely wide range of materials, produce negligible thermal damage, and provide the capability for very clean small features. These features make ultrashort-pulse lasers a promising tool for microfabrication, thin film formation, laser cleaning, and medical and biological applications.

However, laser machining of a substrate tends to result in unwanted heat transfer to a substrate resulting in a heat affected zone. The heat affected zone is a region on the target material that is not removed, but is affected by heat due to the laser. The properties of material in the zone can be adversely affected by heat from the laser. Therefore, it is generally desirable to reduce or eliminate heat input beyond removed material, thus reducing or eliminating the heat affected zone.

One of the many medical applications for laser machining includes fabrication of radially expandable endoprostheses, which are adapted to be implanted in a bodily lumen. An “endoprosthesis” corresponds to an artificial device that is placed inside the body. A “lumen” refers to a cavity of a tubular organ such as a blood vessel.

A stent is an example of such an endoprosthesis. Stents are generally cylindrically shaped devices, which function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of the diameter of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

The treatment of a diseased site or lesion with a stent involves both delivery and deployment of the stent. “Delivery” refers to introducing and transporting the stent through a bodily lumen to a region, such as a lesion, in a vessel that requires treatment. “Deployment” corresponds to the expanding of the stent within the lumen at the treatment region. Delivery and deployment of a stent are accomplished by positioning the stent about one end of a catheter, inserting the end of the catheter through the skin into a bodily lumen, advancing the catheter in the bodily lumen to a desired treatment location, expanding the stent at the treatment location, and removing the catheter from the lumen.

In the case of a balloon expandable stent, the stent is mounted about a balloon disposed on the catheter. Mounting the stent typically involves compressing or crimping the stent onto the balloon. The stent is then expanded by inflating the balloon. The balloon may then be deflated and the catheter withdrawn. In the case of a self-expanding stent, the stent may be secured to the catheter via a retractable sheath or a sock. When the stent is in a desired bodily location, the sheath may be withdrawn which allows the stent to self-expand.

The stent must be able to satisfy a number of mechanical requirements. First, the stent must be capable of withstanding the structural loads, namely radial compressive forces, imposed on the stent as it supports the walls of a vessel. Therefore, the stent must possess adequate radial strength. Radial strength, which is the ability of a stent to resist radial compressive forces, is due to strength and rigidity around a circumferential direction of the stent. Radial strength and rigidity, therefore, may also be described as hoop or circumferential strength and rigidity.

Once expanded, the stent must adequately maintain its size and shape throughout its service life despite the various forces that may come to bear on it, including the cyclic loading induced by the beating heart. For example, a radially directed force may tend to cause a stent to recoil inward. Generally, it is desirable to minimize recoil. In addition, the stent must possess sufficient flexibility to allow for crimping, expansion, and cyclic loading. Finally, the stent must be biocompatible so as not to trigger any adverse vascular responses.

The structure of a stent is typically composed of scaffolding that includes a pattern or network of interconnecting structural elements often referred to in the art as struts or bar arms. The scaffolding can be formed from wires, tubes, or sheets of material rolled into a cylindrical shape. The scaffolding is designed so that the stent can be radially compressed (to allow crimping) and radially expanded (to allow deployment).

Stents have been made of many materials such as metals and polymers, including biodegradable polymeric materials. Biodegradable stents are desirable in many treatment applications in which the presence of a stent in a body may be necessary for a limited period of time until its intended function of, for example, achieving and maintaining vascular patency and/or drug delivery is accomplished.

Stents can be fabricated by forming patterns on tubes or sheets using laser cutting. However, as indicated above, the use of laser machining can have adverse effects on mechanical and other properties in a heat affected zone. Therefore, it is also desirable to reduce or eliminate the heat affected zone resulting from laser machining processes of stents.

### SUMMARY OF THE INVENTION

Various embodiments of the present invention includes a method of fabricating a stent, comprising: directing a pulsed laser beam through a focusing head of a laser machining apparatus to a surface of a tubular construct comprising a polymer layer, wherein the laser beam cuts material of the construct to form a stent pattern; and introducing a cold gas stream into a port of the focusing head, wherein the cold gas stream flows through the focusing head onto and cools the surface of the tubular construct to reduce or prevent heat transfer to uncut polymer of the polymer layer.

Additional embodiments of the present invention include a method of fabricating a stent, comprising: directing a pulsed laser beam through a focusing head of a laser machining apparatus to a surface of a tubular construct comprising a polymer layer, wherein the laser beam cuts material of the construct to form a stent pattern; and directing a cold fluid from a location exterior and adjacent to the focusing head onto the surface of the construct to reduce or prevent heat transfer to uncut polymer of the polymer layer.

Further embodiments of the present invention include a method of fabricating a stent, comprising: directing a pulsed laser beam from a laser source to a surface of a tubular construct comprising a polymer layer, wherein the laser beam cuts material of the construct to form a stent pattern; and directing a cold fluid into a distal or proximal opening of the tubular construct, wherein the cold fluid reduces or prevents heat transfer to uncut polymer of the polymer layer.

### BRIEF DESCRIPTION OF THE DRAWINGS

FIG. 1 depicts a stent.

FIG. 2 depicts an embodiment of a portion of a machine-controlled system for laser machining a tube.

FIG. 3 illustrate embodiments of cooling a machined area with a cooling fluid.

FIG. 4 depicts a close-up axial view of a region where a laser beam interacts with a tube.

FIG. 5 illustrates another aspect of localized cooling which shows an expanded view of the tube during machining.

FIG. 6 depicts a tube with a substrate layer with an outer coating layer.

FIG. 7 depicts spray coating of a tube.

### DETAILED DESCRIPTION OF THE INVENTION

Embodiments of the present invention include methods of cooling a machined substrate during laser machining fabrication of a medical device to reduce or eliminate a heat affected zone. Embodiments also include making a medical device from a construct, such as a stent, that includes a therapeutic agent. Although the methods apply to any laser machining technique, the methods are particularly relevant to ultrashort-pulse laser machining of substrates. These embodiments are suitable for fabricating fine and intricate structures of implantable medical devices such as stents. “Ultrashort-pulse lasers” refer to lasers having pulses with widths or durations shorter than about a picosecond (=10⁻¹²). “Pulse width” refers to the duration of an optical pulse versus time. The duration can be defined in more than one way. Specifically, the pulse duration can be defined as the full width at half maximum (FWHM) of the optical power versus time.

Ultrashort-pulse lasers can include both picosecond and femtosecond (=10⁻¹⁵) lasers. The ultrashort-pulse laser is clearly distinguishable from conventional continuous wave and long-pulse lasers (nanosecond (10⁻⁹) laser) which have significantly longer pulses. In particular, embodiments of the present method employ femtosecond lasers that have pulses shorter than about 10⁻¹³ second.

The ultrashort-pulse lasers are known to artisans. For example, they are thoroughly disclosed by M. D. Perry et al. in Ultrashort-Pulse Laser Machining, Section K-ICALEO 1998, pp. 1-20. Representative examples of femtosecond lasers include, but are not limited to, a Ti:sapphire laser (735 nm-1035 nm) and an excimer-dye laser (220 nm-300 nm, 380 nm-760 nm).

Longer-pulse lasers remove material from a surface principally through a thermal mechanism. The laser energy that is absorbed results in a temperature increase at and near the absorption site. As the temperature increases to the melting or boiling point, material is removed by conventional melting or vaporization. Depending on the pulse duration of the laser, the temperature rise in the irradiated zone may be very fast, resulting in thermal ablation and shock. An advantage of ultrashort-pulse lasers over longer-pulse lasers is that the ultrashort-pulse laser deposits its energy so fast that it does not interact with the plume of vaporized material, which would distort and bend the incoming beam and produce a rough-edged cut. Unlike long-pulse lasers, ultrashort-pulse lasers allow material removal by a nonthermal mechanism. Extremely precise and rapid machining can be achieved with minimal thermal ablation and shock. The nonthermal mechanism involves optical breakdown in the target material which results in material removal.

As indicated above, embodiments of the laser machining method described above may be used in the fabrication of implantable medical devices such as stents. In general, stents can have virtually any structural pattern that is compatible with a bodily lumen in which it is implanted. Typically, a stent is composed of a pattern or network of circumferential rings and longitudinally extending interconnecting structural elements of struts or bar arms. In general, the struts are arranged in patterns, which are designed to contact the lumen walls of a vessel and to maintain vascular patency. A myriad of strut patterns are known in the art for achieving particular design goals such as radial strength, expansion ratio or coverage area, and longitudinal flexibility.

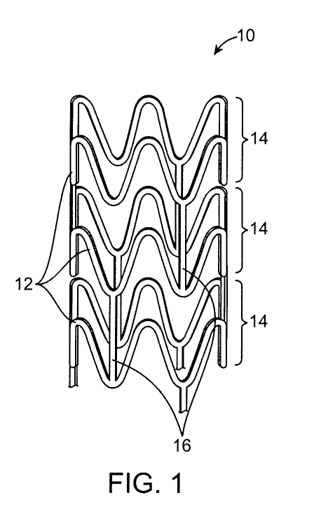

An exemplary structure of a stent is shown in FIG. 1. FIG. 1 depicts a stent 10 which is made up of struts 12. Stent 10 has interconnected cylindrical rings 14 connected by linking struts or links 16. The embodiments disclosed herein are not limited to fabricating stents or to the stent pattern illustrated in FIG. 1. The embodiments are easily applicable to other stent patterns and other devices. The variations in the structure of patterns are virtually unlimited. The outer diameter of a fabricated stent may be between about 0.2-5.0 mm, or more narrowly between about 1-3 mm. In an embodiment, the length of the stents may be between about 7-9 mm.

Laser machining may used to fabricate stents from a variety of materials. For example, a stent pattern may be cut into materials including polymers, metals, or a combination thereof. Polymers can be biostable, bioabsorbable, biodegradable, or bioerodable. Biostable refers to polymers that are not biodegradable. The terms biodegradable, bioabsorbable, and bioerodable, as well as degraded, eroded, and absorbed, are used interchangeably and refer to polymers that are capable of being completely eroded or absorbed when exposed to bodily fluids such as blood and can be gradually resorbed, absorbed, and/or eliminated by the body. In addition, a medicated stent may be fabricated by coating the surface of the stent with an active agent or drug, or a polymeric carrier including an active agent or drug. An active agent can also be incorporated into the scaffolding of the stent.

A stent made from a biodegradable polymer is intended to remain in the body for a duration of time until its intended function of, for example, maintaining vascular patency and/or drug delivery is accomplished. After the process of degradation, erosion, absorption, and/or resorption has been completed, no portion of the biodegradable stent, or a biodegradable portion of the stent will remain. In some embodiments, very negligible traces or residue may be left behind. The duration can be in a range from about a month to a few years. However, the duration is typically in a range from about one month to twelve months, or in some embodiments, six to twelve months.

An implantable medical device, such as a stent, can be fabricated by laser machining a construct to form the device. Material is removed from selected regions of the construct which results in formation of the structure of the device. In particular, a stent may be fabricated by machining a thin-walled tubular member with a laser. Selected regions of the tubing may be removed by laser machining to obtain a stent with a desired pattern.

Specifically, a beam can be translated or scanned over the surface of a construct resulting in removal of a trench or kerf extending all the way through a wall of the construct. The kerf width can be approximately the diameter of the beam or spot size on the substrate. The interaction of the beam with a process or assist gas can result in a kerf width wider than the diameter of the beam on the substrate. Alternatively, a stent may be fabricated by machining a sheet in a similar manner, followed by rolling and bonding the cut sheet to form the stent.

The rate of device fabrication with laser machining is an important factor in any manufacturing process. Increasing or maximizing process throughput can be accomplished by adjusting relevant process parameters. The repetition rate of a laser pulse is directly related to the rate of cutting or material removal from a construct. Thus, increasing the repetition rate allows increase of the scan rate of the laser across a substrate resulting in an increase in process throughput. However, the repetition rate is directly related to the rate of heat generation. Thus, as the repetition rate increases, the heat transfer to the substrate increases.

Femtosecond pulsed lasers typically used for fabricating implantable medical devices such as stents have a repetition rate of between 1 and 5 kHz. Femtosecond pulsed lasers have pulse widths less than 10⁻¹² seconds, less than 500 fs, 100-500 fs, 80-100 fs, 10-80 fs, or less than 10 fs. The energy per pulse and fluence of the laser is high enough to cut or ablate construct materials such as polymers, metals, and ceramics. An energy per pulse and fluence (based on a 10 micron spot size) for laser cutting polymers is at least 4-200 μJ and 0.5-200 KJ/cm², respectively. The average power per pulse of a beam can be 0.01-4 W, or more narrowly 0.5-2 W. The peak power per pulse of a beam can be 12.5-5000 MW, or more narrowly 6.25-2500 MW.

An exemplary beam can have a wavelength of 800 nm and a power of 1.4 W. The energy per pulse for this beam in a 1-5 kHz repetition rate range can have a range of 1400-280 μJ with a fluence of 1783-357 mJ/cm² based on a 10 micron spot size. The peak power for this beam for a 500 fs pulse width is 28000-560 MW. The peak power for a 100 fs pulse width is 14000 MW-2800 MW. The peak power for a 80 fs pulse width is 17,500-3500 MW. The peak power for a 10 fs pulse width is 140,000-28,000 MW.

Embodiments of the present invention can also include laser machining with femtosecond pulse widths with repetition rates greater than 5 kHz, for example, between 5 and 10 KHz. Pulse widths may be less than 10⁻¹² seconds, less than 500 fs, 100-500 fs, 80-100 fs, 10-80 fs, or less than 10 fs. The energy per pulse and fluence of the laser is high enough to cut or ablate constrict materials such as polymers, metals, and ceramics. The average power per pulse of a beam can be 0.01-4 W, or more narrowly 0.5-2 W. The peak power per pulse of a beam can be 12.5-5000 MW, or more narrowly 6.25-2500 MW.

An exemplary beam can have a wavelength of 800 nm and a power of 1.4 W. The energy per pulse for this beam in a 5-10 kHz repetition rate range can have a range of 140-280 μJ with a fluence of 178-357 mJ/cm² based on a 10 micron spot size. The peak power for this beam for a 500 fs pulse width is 280-560 MW. The peak power for a 100 fs pulse width is 1400-2800 MW. The peak power for a 80 fs pulse width is 3500-1750 MW. The peak power for a 10 fs pulse width is 280,000-14000 MW.

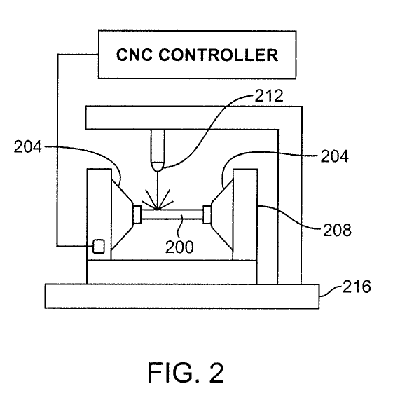

In exemplary embodiments, a stent can be cut from a tubing using a machine-controlled laser as illustrated schematically in FIG. 2. FIG. 2 depicts an embodiment of a portion of a machine-controlled system for laser machining a tube. In FIG. 2, a tube 200 is disposed in a rotatable collet fixture 204 of a machine-controlled apparatus 208 for positioning tubing 200 relative to a laser 212. According to machine-encoded instructions, tube 200 is rotated and moved axially relative to laser 212 which is also machine-controlled. The laser selectively removes the material from the tubing resulting in a pattern cut into the tube. The tube is therefore cut into the discrete pattern of the finished stent.

Even ultrashort-pulse laser machining tends to result in a heat affected zone, i.e., a portion of the target substrate that is not removed, but is still heated by the beam. The heating may be due to exposure of the substrate from a section of the beam with an intensity that is not great enough to remove substrate material through either a thermal or nonthermal mechanism. For example, the portions of a beam near its edges may not have an intensity sufficiently high to induce formation of a plasma. Most beams have an uneven or nonuniform beam intensity profile, for example, a Gaussian beam profile.

A heat affected zone in a target substrate is undesirable for a number of reasons. In both metals and polymers, heat can cause thermal distortion and roughness at the machined surface. Polymers are particularly sensitive to heat. The heat can cause chemical degradation that can affect the mechanical properties and degradation rate.

Additionally, heat can modify molecular structure of a polymer, such as degree of crystallinity and polymer chain alignment. Mechanical properties are highly dependent on molecular structure. For example, a high degree of crystallinity and/or polymer chain alignment is associated with a stiff, high modulus material. Heating a polymer above its melting point can result in an undesirable increase or decrease in crystallinity once the polymer resolidifies. Melting a polymer may also result in a loss of polymer chain alignment, which can adversely affect mechanical properties.

Additionally, it may be desirable to fabricate a medicated stent by laser cutting a drug-impregnated polymer tube. Polymer or metal stent bodies preformed by laser cutting are typically coated with polymer and drug mixture by using spray, dipping, caulking, etc. The polymer and drug are dissolved in a solvent for the coating process. The polymers used in the coating solution typically are of low molecular weight (e.g., less than 50 or 100 kg/mol) to obtain a low viscosity solution. This allows a coating solution to spread more evenly over the complex geometry of a stent structure. In addition, the resulting polymer coating can be amorphous and with no preferential orientation of polymer chains.

The resulting coating layer from this process can be brittle due to the low molecular weight, low degree of polymer chain orientation, and amorphous morphology. Thus, the coating is susceptible to cracks in high strain areas when a stent is crimped, bent, or deployed. This can lead to defects on the stent and drug distribution.

A solution to this problem is forming a coating on a polymer or metal tube surface, or both, that is less susceptible to cracking followed by laser machining to form the stent. The polymer coating can include a drug dispersed through the coating polymer. A drawback of this scheme is that the drugs normally have lower decomposition temperature than a polymer melt temperature. Drug decomposition temperatures are typically in the range of 80-100° C. During laser processing, drugs may decompose due to heat transferred to the material from laser processing. Thus, stents are typically cut first with a laser and then coated with polymer/drug mixture to avoid such decomposition.

Embodiments of the present invention are directed to reducing or eliminating a heat affected zone, or more generally, reducing or eliminating heat transfer to an uncut substrate during laser machining through localized cooling of a laser machine surface. In particular, the localized heating reduces heat transfer when machining at high repetition rates. Additionally, the present invention is directed to laser cutting a tube that includes a drug or therapeutic agent and reducing or eliminating heat transfer to the tube to reduce or eliminate drug decomposition. In these embodiments, the polymer coating can have a high resistance to fracture, as described in more detail below.

Various embodiments of localized cooling can include directing a cold liquid or gas stream at a machined area of a substrate. In some embodiments, a cold gas stream can be directed into the focusing head of a laser and through a nozzle along the beam axis. In other embodiments, a cold gas or liquid stream can be blown into a distal or proximal opening of a machined tube to cool a machined area. In additional embodiments, the cold gas or liquid stream can be directed from a point exterior and adjacent to a beam source or focusing head at a machined area. In still other embodiments, more than one cold gas or liquid stream can be directed at the machined area. Additionally, a cold gas or liquid stream can be directed from various locations adjacent to the machined area.

A cold gas stream can include, but is not limited to, dry ice vapor, liquid nitrogen vapor, or a chilled gas, such as helium, argon, oxygen, carbon dioxide, or air. A cold liquid stream can include chilled water, isopropyl alcohol, or any other liquid that does not dissolve the polymer of the tube. The temperature of a cold gas or liquid stream can be less than 25° C., 10° C., 0° C., −10° C., or less than −30° C.

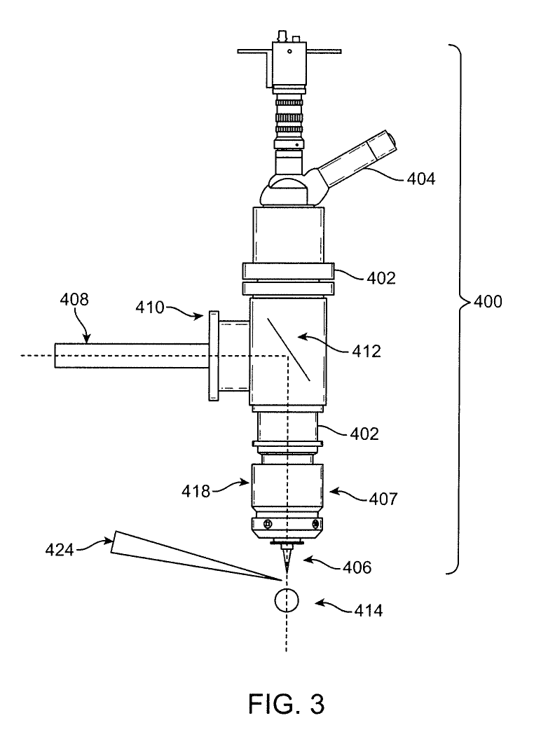

FIG. 3 depicts a portion of a laser machining apparatus including a focusing head 400. Focusing head 400 includes a shaft 402, a viewing section 404, and a nozzle 406. A focusing lens (not shown) is positioned within shaft section 407. A laser beam 408 enters focusing head 400 at a port 410. Beam 408 is reflected off mirror 412 and directed through shaft 402 and nozzle 406 onto tube 414, which is shown in radial cross-section.

In one aspect of localized cooling of a machined substrate, a cold gas stream is introduced into focusing head 400 as indicated by an arrow 418. The cold gas stream exits nozzle 406 and is directed onto a machined area of tube 414.

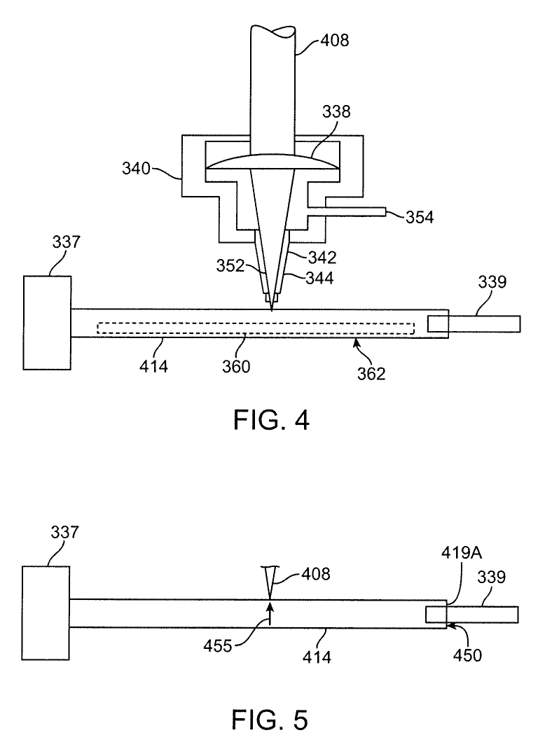

FIG. 4 depicts a close-up view of the focusing head and nozzle. Laser beam 408 is focused by a focusing lens 338 on a tube 414. Tube 414 is supported by a controlled rotary collet 337 at one end and a tube support pin 339 at another end. FIG. 4 further illustrates another aspect of localized cooling. As shown in FIG. 4, focusing head 400 includes a coaxial gas jet assembly 340 for a cold gas jet or stream 342 that exits through a nozzle 344 that cools the machined surface as the beam cuts and vaporizes a substrate. The gas stream also helps to remove debris from the kerf and cool the region where the beam. Gas input is shown by an arrow 354. Coaxial gas jet nozzle 344 is centered around a focused beam 352. In some embodiments, the pressure of the supplied cooling gas is between 30 and 100 psi.

It may also be necessary to block laser beam 414 as it cuts through the top surface of the tube to prevent the beam, along with the molten material and debris from the cut, from impinging on the inside opposite surface of tube 414. To this end, a mandrel 360 supported by a mandrel beam block 362 is placed inside the tube and is allowed to roll on the bottom of the tube 348 as the pattern is cut. This acts as a beam/debris block protecting the far wall inner diameter.

FIG. 5 illustrates another aspect of localized cooling which shows an expanded view of the tube 414 during machining. A cold gas or liquid stream is introduced into a proximal end 414A of tube 414. The cold gas or liquid stream is blown out from inside of the tubing to cool the tube during machining, as shown by an arrow 455. The gas stream further removes particulate and dust from the machining process.

In a further embodiment, a cold gas or liquid stream 424 can be introduced from a position exterior and adjacent to nozzle 406 onto a machined area to cool the machined area and remove any loose particulates or dust generated by the laser machining.

In some embodiments, a machined tubular construct includes a therapeutic agent or drug. The cooling of the surface with a cold gas or liquid reduces or prevents degradation of the therapeutic agent in the uncut material of the tubular polymer construct. The drug can be mixed or dispersed in at least a portion of the tubular construct.

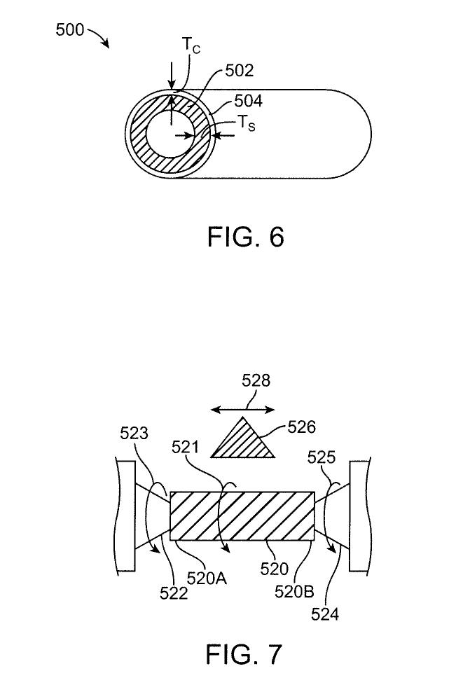

In certain embodiments, a polymer or metal tube, formed, for example, by extrusion, includes a polymer and drug coating layer. The coating can be on the outer surface (abluminal), inner surface (luminal), or both the inner and outer surfaces of the tube. Thus, the tube includes a substrate layer made of polymer or metal and one or two polymer and drug coating layers. FIG. 6 depicts a tube 500 with a substrate layer 502 with an outer coating layer 504. Substrate layer 502 has a thickness Ts and coating layer 504 has a thickness Tc. An exemplary range of Ts can be less than 0.03 mm, between 0.03-0.1 mm, or greater than 0.1 mm. An exemplary range of Tc is less than 3 μm, between 3-10 μm, or greater than 10 μm.

The fracture toughness of the coating can be enhanced by circumferential alignment of the polymer chains of the coating polymer. Such alignment can be provided by application of polymer/drug/solvent coating material on a rotating tube. FIG. 7 depicts a tube 520 with its proximal end 520A and distal end 520B mounted over rotatable collets 522 and 524, respectively. Collets 522 and 524 rotate as shown by arrows 523 and 525, respectively, which rotates tube 520, as shown by an arrow 521. A spray plume 526 of coating material from a spray nozzle (not shown) is deposited on the surface of tube 520 as it rotates. The coating material includes a polymer dissolved in a solvent and a drug dispersed with the solvent. The spray nozzle can translate laterally as shown by arrow 528 to deposit coating material along the length of the tube. The solvent from the deposited coating material is removed to form a polymer/drug coating over the tube. The resultant polymer of the coating has preferential alignment of polymer chains in the circumferential direction. As a result, the coating has increased fracture toughness over a coating applied over a stent body without inducing circumferential orientation. Subsequent to the coating process, a stent pattern can be cut into the tube using the laser machining methods described above. The resulting stent will have structural elements with an abluminal layer corresponding to layer 502 and coating layer 504 of FIG. 6.

The fracture toughness may also be enhanced by using a high molecular weight polymer in the coating material. For example, the molecular weight can be greater than 100 kg/mol, 100-150 kg/mol, or greater than 150 kg/mol. It is expected that the higher viscosity of the coating solution can spread evenly over the tube surface during a coating operation, unlike a complex geometry of a stent structure. In an exemplary embodiment, the coating polymer is poly(DL-lactide) with a molecular weight greater than 100 g/mol. The PDLA coating solution is applied to a PLLA tube.

Representative examples of polymers that may be used to fabricate embodiments of implantable medical devices disclosed herein include, but are not limited to, poly(N-acetylglucosamine) (Chitin), Chitosan, poly(3-hydroxyvalerate), poly(lactide-co-glycolide), poly(3-hydroxybutyrate), poly(4-hydroxybutyrate), poly(3-hydroxybutyrate-co-3-hydroxyvalerate), polyorthoester, polyanhydride, poly(glycolic acid), poly(glycolide), poly(L-lactic acid), poly(L-lactide), poly(D,L-lactic acid), poly(D,L-lactide), poly(L-lactide-co-D,L-lactide), poly(caprolactone), poly(L-lactide-co-caprolactone), poly(D,L-lactide-co-caprolactone), poly(glycolide-co-caprolactone), poly(trimethylene carbonate), polyester amide, poly(glycolic acid-co-trimethylene carbonate), co-poly(ether-esters) (e.g. PEO/PLA), polyphosphazenes, biomolecules (such as fibrin, fibrinogen, cellulose, starch, collagen and hyaluronic acid), polyurethanes, silicones, polyesters, polyolefins, polyisobutylene and ethylene-alphaolefin copolymers, acrylic polymers and copolymers, vinyl halide polymers and copolymers (such as polyvinyl chloride), polyvinyl ethers (such as polyvinyl methyl ether), polyvinylidene halides (such as polyvinylidene chloride), polyacrylonitrile, polyvinyl ketones, polyvinyl aromatics (such as polystyrene), polyvinyl esters (such as polyvinyl acetate), acrylonitrile-styrene copolymers, ABS resins, polyamides (such as Nylon 66 and polycaprolactam), polycarbonates, polyoxymethylenes, polyimides, polyethers, polyurethanes, rayon, rayon-triacetate, cellulose acetate, cellulose butyrate, cellulose acetate butyrate, cellophane, cellulose nitrate, cellulose propionate, cellulose ethers, and carboxymethyl cellulose. Additional representative examples of polymers that may be especially well suited for use in fabricating embodiments of implantable medical devices disclosed herein include ethylene vinyl alcohol copolymer (commonly known by the generic name EVOH or by the trade name EVAL), poly(butyl methacrylate), poly(vinylidene fluoride-co-hexafluoropropene) (e.g., SOLEF 21508, available from Solvay Solexis PVDF, Thorofare, N.J.), polyvinylidene fluoride (otherwise known as KYNAR, available from ATOFINA Chemicals, Philadelphia, Pa.), ethylene-vinyl acetate copolymers, poly(vinyl acetate), styrene-isobutylene-styrene triblock copolymers, and polyethylene glycol.

Additionally, substrate or scaffolding of a stent may also be composed partially or completely of biostable or bioerodible metals. Some metals are considered bioerodible since they tend to erode or corrode relatively rapidly when exposed to bodily fluids. Biostable metals refer to metals that are not bioerodible. Biostable metals have negligible erosion or corrosion rates when exposed to bodily fluids. Representative examples of biodegradable metals that may be used to fabricate stents may include, but are not limited to, magnesium, zinc, and iron. Biodegradable metals can be used in combination with biodegradable polymers.

Representative examples of metallic material or an alloy that may be used for fabricating a stent include, but are not limited to, cobalt chromium alloy (ELGILOY), stainless steel (316L), high nitrogen stainless steel, e.g., BIODUR 108, cobalt chrome alloy L-605, “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from Standard Press Steel Co., Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum.

For example, a stainless steel tube or sheet may be Alloy type: 316L SS, Special Chemistry per ASTM F138-92 or ASTM F139-92 grade 2. Special Chemistry of type 316L per ASTM F138-92 or ASTM F139-92 Stainless Steel for Surgical Implants in weight percent. An exemplary weight percent may be as follows: Carbon (C) 0.03% max; Manganese (Mn): 2.00% max; Phosphorous (P): 0.025% max.; Sulphur (S): 0.010% max.; Silicon (Si): 0.75% max.; Chromium (Cr): 17.00-19.00%; Nickel (Ni): 13.00-15.50%; Molybdenum (Mo): 2.00-3.00%; Nitrogen (N): 0.10% max.; Copper (Cu): 0.50% max.; fron (Fe): Balance.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A method of fabricating a stent, comprising:
directing a pulsed laser beam through a focusing head of a laser machining apparatus to a surface of a tubular construct comprising a polymer layer, wherein the laser beam cuts material of the construct to form a stent pattern; and
introducing a cold gas stream into a port of the focusing head, wherein the cold gas stream flows through the focusing head onto and cools the surface of the tubular construct to reduce or prevent heat transfer to uncut polymer of the polymer layer.

2. The method of claim 1, wherein the tubular construct comprises a polymer tube and the polymer layer, the polymer layer being disposed over an outer surface of the polymer tube.

3. The method of claim 1, wherein the tubular construct comprises a metallic tube and the polymer layer, the polymer layer being disposed over an outer surface of the metallic tube.

4. The method of claim 1, wherein the polymer layer comprises a therapeutic agent, the cooling reducing or preventing decomposition of the therapeutic agent in the uncut polymer.

5. The method of claim 1, wherein the pulse width of the laser beam is less than 100 fs.

6. The method of claim 1, wherein a repetition rate of the pulsed beam is greater than 5 kHz.

7. A method of fabricating a stent, comprising:
directing a pulsed laser beam through a focusing head of a laser machining apparatus to a surface of a tubular construct comprising a polymer layer, wherein the laser beam cuts material of the construct to form a stent pattern; and
directing a cold fluid from a location exterior and adjacent to the focusing head onto the surface of the construct to reduce or prevent heat transfer to uncut polymer of the polymer layer.

8. The method of claim 7, wherein the tubular construct comprises a polymer tube and the polymer layer, the polymer layer being disposed over an outer surface of the polymer tube.

9. The method of claim 7, wherein the tubular construct comprises a polymer tube and the polymer layer, the polymer layer being disposed over an outer surface of the polymer tube.

10. The method of claim 7, wherein the polymer layer comprises a therapeutic agent, the cooling reducing or preventing decomposition of the therapeutic agent in the uncut polymer.

11. The method of claim 7, wherein the pulse width of the laser beam is less than 100 fs.

12. The method of claim 7, wherein the cold fluid comprises a cold gas selected from the group consisting of nitrogen, oxygen, argon, and air.

13. The method of claim 7, wherein the cold fluid comprises a liquid that is a poor solvent for the polymer of the polymer layer.

14. The method of claim 13, wherein the polymer of the polymer layer is PLLA and the cold fluid is selected from the group consisting of water and isopropyl alcohol.

15. A method of fabricating a stent, comprising:
directing a pulsed laser beam from a laser source to a surface of a tubular construct comprising a polymer layer, wherein the laser beam cuts material of the construct to form a stent pattern; and
directing a cold fluid into a distal or proximal opening of the tubular construct, wherein the cold fluid reduces or prevents heat transfer to uncut polymer of the polymer layer.

16. The method of claim 15, wherein the tubular construct comprises a polymer tube and the polymer layer, the polymer layer being disposed over an outer surface of the polymer tube.

17. The method of claim 15, wherein the tubular construct comprises a metallic tube and the polymer layer, the polymer layer being disposed over an outer surface of the metallic tube.

18. The method of claim 15, wherein the polymer layer comprises a therapeutic agent, the cooling reducing or preventing decomposition of the therapeutic agent in the uncut polymer.

19. The method of claim 15, wherein the pulse width of the laser beam is less than 100 fs.

20. The method of claim 15, wherein the cold fluid comprises a cold gas selected from the group consisting of nitrogen, oxygen, argon, and air.

21. The method of claim 15, wherein the cold fluid comprises a liquid that is a poor solvent for the polymer of the polymer layer.

22. The method of claim 21, wherein the polymer of the polymer layer is PLLA and the cold fluid is selected from the group consisting of water and isopropyl alcohol.
